(19) United States
(12) Patent Application Publication
(10) Pub. No.: US 2002/0033879 A1
(43) Pub. Date: Mar. 21, 2002

(54) Remote face-to-face communication apparatus in which self-facial expression can be checked

(76) Inventors: Jun Yoshimoto, Tokyo (JP); Hiroyuki Yano, Tokyo (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/946,135

(22) Filed: Sep. 5, 2001

(30) Foreign Application Priority Data
Sep. 5, 2000 (JP) 2000-268193

(51) Int. Cl. H04N 7/14

(52) U.S. Cl. 348/14.08

(57) ABSTRACT

The present invention provides a remote face-to-face communication apparatus in which the user can exchange glance with other users and can check self-facial expression, connected to other communication apparatus to be used in the communication system for transmitting the images of the users between each communication apparatus comprising: shooting means disposed in the direction of the user's sight line, first display means for displaying the image received from other communication apparatuses, second display means for displaying the image shot by the shooting means, image transmitting means for distributing and transmitting the image shot by the shooting means to other communication apparatus and the second display means, wherein a half mirror being disposed on the optical axis of the shooting means and a mirror being disposed at the position opposing to the half mirror, whereby the image of the user passed through the half mirror is shot and the image displayed on the first display means is reflected off the mirror and the half mirror to make it visible to the user.

According to the remote face-to-face communicating apparatus, the users of the video conference apparatus or the like can exchange glance with each other and can check their own facial expression to be transmitted to the other party, so that a natural conversation with realistic sensation is realized.

### BACKGROUND OF THE INVENTION

1. Field of the Invention

The present invention relates to a remote face-to-face communication apparatus in which the user can exchange glance with other users and can check self-facial expression during videoconference or the like.

2. Description of the Related Art

In the videoconference system of the related art, the terminals each comprising shooting means such as a video camera and displaying means such as a video monitor are installed at a plurality of locations connected by the communication lines to transmit the image of participants shot by the video camera or the like to other ends of the line with each other via the communication lines so as to be capable of having conference while viewing the image of the other party.

However, in the videoconference system of the related art, the monitor for displaying the images of the other parties and the camera for shooting the user are disposed at a distant apart. Therefore, when the user fixes his/her eyes on the monitor, the sight line is not brought into line with the optical axis of the camera, and thus the monitors on other parties display the image of the user looking in the different direction. In addition, since the user cannot check his/her own facial expression that is to be transmitted to the other party, the conference using the videoconference system may disadvantageously results in communication without realistic sensations, which is far from a natural conversation.

### SUMMARY OF THE INVENTION

Accordingly, it is an object of the present invention to solve the problems of the related art and to provide a remote face-to-face communication apparatus that enables a natural conversation with realistic sensations by exchanging glance of the users of the videoconference system or the like with each other, and enabling the user to check his/her own facial expression transmitted to the other part.

According to the present invention, there is provided a remote face-to-face communication apparatus in which the user can exchange glance with other users and can check self-facial expression, connected to other communication apparatus to be used in the communication system for transmitting the images of the users between each communication apparatus comprising: shooting means disposed in the direction of the user's sight line, first display means for displaying the image received from other communication apparatuses, second display means for displaying the image shot by the shooting means, image transmitting means for distributing and transmitting the image shot by the shooting means to other communication apparatus and the second display means, a half mirror disposed on the optical axis of the shooting means, and a mirror disposed at the position opposing to the half mirror, wherein the image of the user passed through the half mirror is shot and the image displayed on the first display means is reflected off the mirror and the half mirror to make it visible to the user.

In the remote face-to-face communication apparatus in which the user can check his/her facial expression according to the present invention, preferably, the image displayed on the second display means as well as the image displayed on the first display means are reflected off the half mirror to make it visible to the user.

In the remote face-to-face communication apparatus in which the user can check his/her facial expression according to the present invention, preferably, the first display means and the second display means are combined so that the image shot by the shooting means and the image received from another communication apparatus are combined to be displayed.

In the remote face-to-face communication apparatus in which the user can check his/her facial expression according to the present invention, preferably, the first display means and the second display means are combined so that either the image shot by the shooting means or the image received from another communicating apparatus is selected to be displayed.

In the remote face-to-face communication apparatus in which the user can check his/her facial expression according to the present invention, preferably, either the image shot by the shooting means or the image received from another communicating apparatus is selected by a foot switch to be displayed.

In the remote face-to-face communication apparatus in which the user can check his/her facial expression according to the present invention, preferably, the image shot by the shooting apparatus and distributed and transmitted to the second display means is mirror reversed in the image transmitting means to be output.

In the remote face-to-face communication apparatus in which the user can check his/her facial expression according to the present invention, preferably, the image shot by the shooting means and distributed and transmitted to the second display means is displayed on the second display means so as to be capable of switching between ON and OFF.

### BRIEF DESCRIPTION OF THE DRAWINGS

FIG. 1 is a pattern diagram showing an example of the construction of the remote face-to-face communicating apparatus according to the present invention;

FIG. 2 is a drawing showing an image displayed on the apparatus shown in FIG. 1;

FIG. 3 is a pattern diagram showing another example of the construction of the remote face-to-face communication apparatus according to the present invention;

FIG. 4 is a drawing showing an image displayed on the apparatus shown in FIG. 3;

FIG. 5 is a diagrammatic drawing showing another example of the construction of the remote face-to-face communication apparatus according to the present invention;

FIG. 6 is a drawing showing an image displayed on the apparatus shown in FIG. 5; and

FIG. 7 is a diagrammatic drawing showing another example of the construction of the remote face-to-face communication apparatus according to the present invention.

### DESCRIPTION OF THE PREFERRED EMBODIMENTS

Referring now to the drawings, the remote face-to-face communication apparatus of the present invention in which the self-facial expression can be checked will be described. However, the present invention is not limited to the following embodiment.

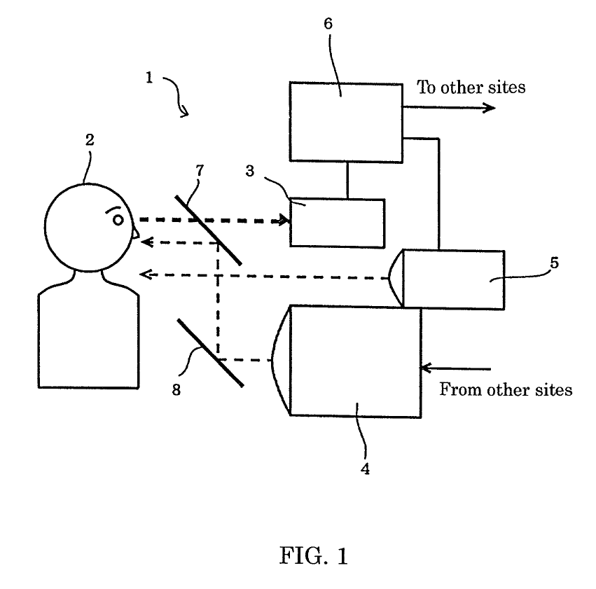

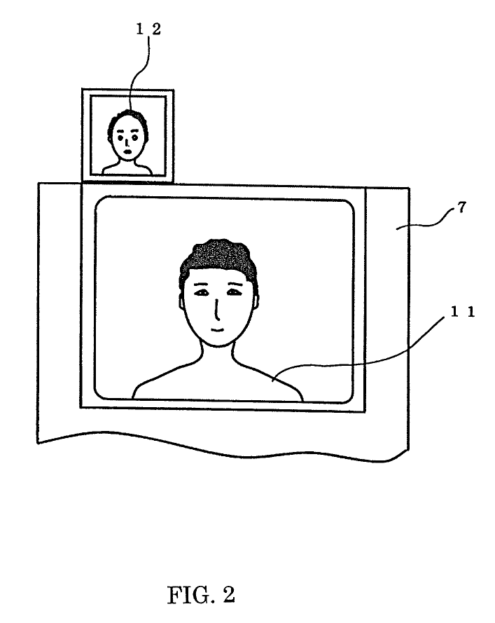

FIG. 1 and FIG. 2 are drawings showing an example of the remote face-to-face communication apparatus according to the present invention. FIG. 1 is a diagrammatic drawing showing the construction of the apparatus installed at a certain communication site. FIG. 2 is an image displayed on the apparatus shown in FIG. 1.

The communication apparatus 1 comprises shooting means 3 disposed in the direction of sight line of the user 2, first display means 4 displaying the image 11 received from another communication apparatus, second display means 5 for displaying the image 12 shot by the shooting means 3, and image transmitting means 6 for distributing and transmitting the image shot by the shooting means 3 to the communication apparatus of other communication site and the second display means 5.

In the communication apparatus 1, a half mirror 7 is disposed on the optical axis of the shooting means 3, and a mirror 8 is disposed at the location opposed to the half mirror 7. In this arrangement, the image of the user 2 is passed through the half mirror 7 and shot, and the image 11 displayed on the first display means 4 is reflected off the mirror 8 and the half mirror 7 to make it visible to the user 2.

The shooting means (camera) 3 is not specially limited, and in the example, the shooting means using a CCD, a C-MOS, or a image-pickup tube that is usually used for the television camera is described as an example. As a first and second displaying means (monitors), a normal display means such as a CRT display, a liquid crystal display, a plasma display, or a projector display may be used. The size of the second monitor 5 that displays the image 12 of the user 2 of the communication apparatus 1 is preferably smaller than the size of the first monitor 4 displaying the image 11 received from another communication apparatus (See FIG. 2).

As a half mirror 7, the optical element that allows at least a part of light to pass through and remaining light to be reflected such as Polarizing Beam Splitters (PBS) or the like may be used as well as the normal half mirror.

In this communication apparatus 1, by disposing the camera 3 on the sight line of the user 2 to shoot the image of the user 2 that passed through the half mirror 7, the image of the user looking straight at the camera 3 can be shot. The image 12 shot in this way is distributed and transmitted to other communication apparatuses (not shown) and the second monitor 5 by the image transmitting means 6.

The image 11 received from another communication apparatus is displayed on the monitor 4, and then is reflected off the mirror 8 and the half mirror 7 to be sent to the user 2. Therefore, the user 2 of the apparatus 1 can, as seen in FIG. 2, see the image 11 of another communication apparatus of the monitor 4 projected on the half mirror 7 and the user's own image 12 on the monitor 5.

The image 11 received from another communication apparatus is shot in the same manner and is of the user looking straight at the camera. Therefore, when the video conference is held with the use of this communication apparatus, the users can communicate with their sight lines directed toward the image 11 of the other party looking straight toward him/her, thereby realizing conference with natural and realistic sensations. In addition, since the user can check his/her own facial expression by his/her own image 12 transmitted to the other party by means of the monitor 5, the users can communicate with each other with an easy conscience.

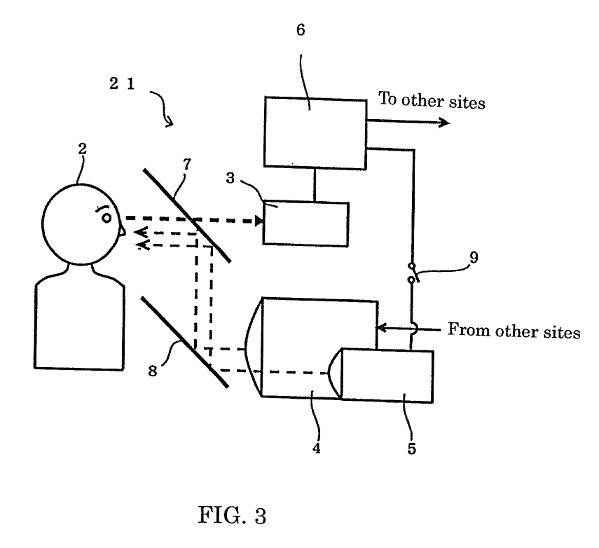

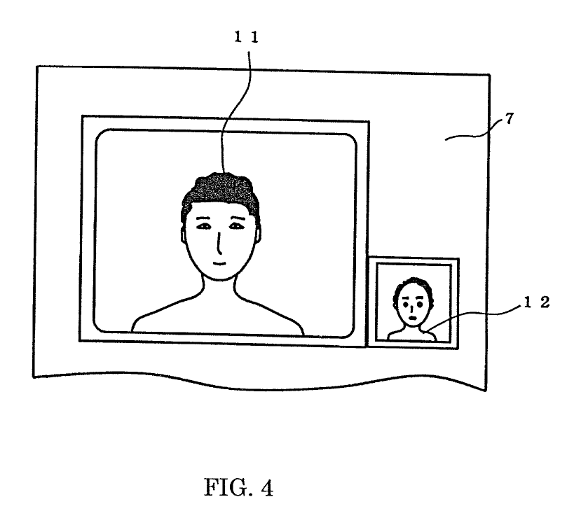

FIG. 3 and FIG. 4 are drawings showing another example of the remote face-to-face communication apparatus according to the present invention. FIG. 3 is a diagrammatic drawing showing the construction of the apparatus, and FIG. 4 is a drawing showing an image shown on the apparatus in FIG. 3.

The apparatus 21 comprises first display means 4 for displaying the image 11 received from another communication means and second display means 5 displaying the user 2's own image 12 arranged side by side, so that both the image 11 and the image 12 are transmitted to the user 2 by allowing them to be reflected off the mirror 8 and the half mirror 7.

A switch 9 is provided in the circuit connecting the image transmitting means 6 and the second display means 5 to enable the image 12 displayed on the second display means 5 to be switched between ON and OFF. This switching operation of the switch 9 may be performed automatically at regular intervals by the use of for example a timer. It is also possible to construct the switch in such a manner that the user 2 changeovers the remote operating switch by hand, or the foot switch by foot. With the switch to be operated by hand, the user's upper half body moves, and thus the other party can see that the user has switched the image, which may result in unnatural conversation. While with the foot switch, the user can switch the image without allowing the other party to sense his/her switching operation, and thus the users can continue natural conversation. In addition, it is also possible to construct the switch in such a manner that the image transmitting means 6 recognizes the magnitude of the movement of the user 2's image 12, and when the magnitude of the movement of the image 12 is large, the switch 9 is closed to allow the second display means 5 to display the image 12. The user 2's own image 12 displayed on the second display means 5 is not necessarily required to be displayed all the time. Therefore, providing the switch 9 to display the image 12 as needed enables the user 2 to concentrate the conversation with the other party.

Other constructions of the communication apparatus 21 are the same as the apparatus 1 shown in FIG. 1 and FIG. 2.

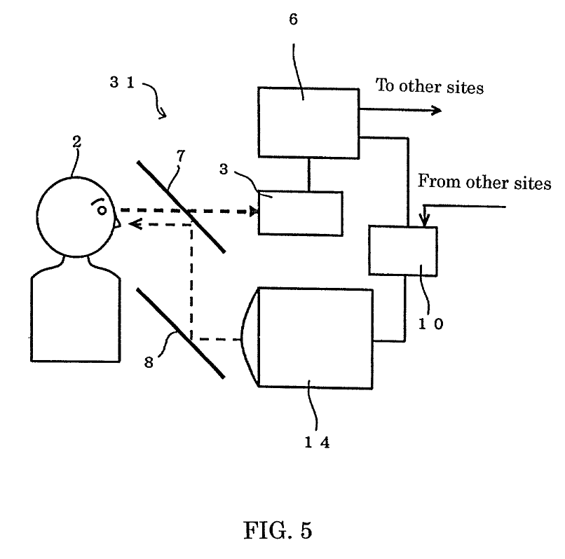

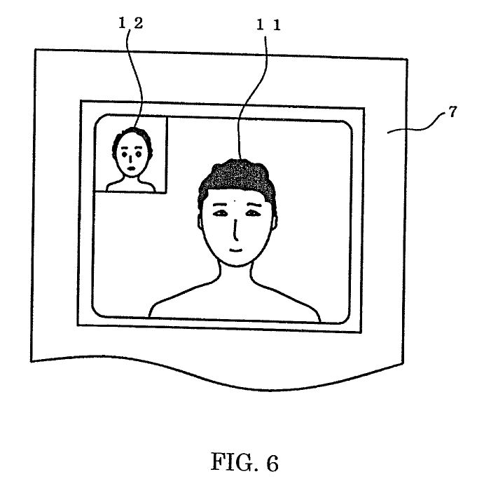

FIG. 5 and FIG. 6 are drawings showing another example of the remote face-to-face communication apparatus of the present invention. FIG. 5 is a diagrammatic drawing showing the construction of the apparatus, and FIG. 6 is a drawing showing the image displayed on the apparatus shown in FIG. 5.

The apparatus 31 comprises display means 14 including first display means and second display means combined together, and image combining means 10 provided in the circuit connecting the image transmitting means 6 and the display means 14. The image 11 received from other communication apparatus and the image 12 of the user 2 distributed by the image transmitting means 6 are combined by the image combining means 10, displayed on the display means 14, and reflected off the mirror 8 and the half mirror 7 to deliver the image for example as shown in FIG. 6 to the user 2.

Other constructions of the communication apparatus 31 are the same as the apparatus 1 shown in FIG. 1 and FIG. 2.

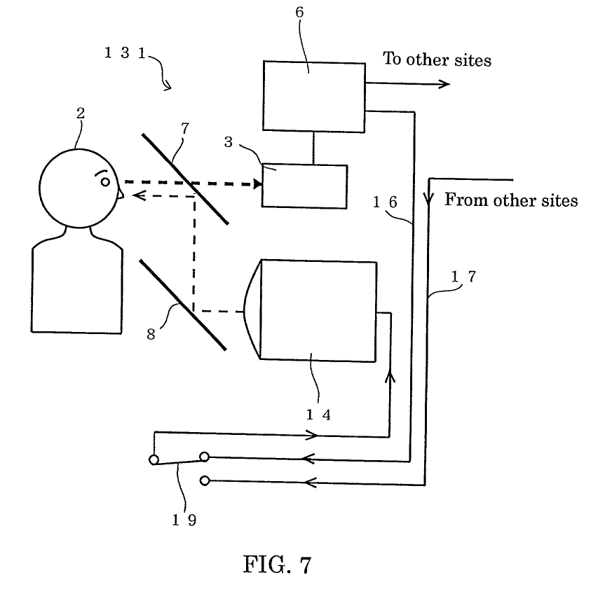

FIG. 7 is a diagrammatic drawing showing other constructions of the remote face-to-face communication apparatus according to the present invention. This apparatus 131 comprises display means 14 including first display means and second display means combined together, a circuit 16 for connecting the image transmitting means 6 and the display means 14, and a circuit 17 for connecting the image 11 received from another communication apparatus with the display means 14, in which the circuit 16 and the circuit 17 are connected to the display means 14 so as to be capable of switching between these circuits by the foot switch 19. In this apparatus 131, one of the image 11 of the other party selected by the foot switch 19 and the user 2's own image 12 is displayed on the entire screen of the display means 14, reflected off the mirror 8 and the half mirror 7, and delivered to the user 2. For example, while the image 11 received from another communication apparatus is displayed on the receiving apparatus 14 in the normal state, when the foot switch 19 is pressed, the user 2's own image 12 can be displayed on the display means 14 to check his/her own facial expression. Since the switching operation of the foot switch is to be made by foot, the user can changeover the switch without allowing the other party to sense this switching operation, thereby realizing natural conversation.

In the detailed embodiments described thus far, the remote face-to-face communication apparatus is applied to the video conference. However, the present invention is not limited thereto, but may be used as an apparatus for having conference among a plurality of participants such as a video telephone in addition to the video conference.

When distributing and transmitting the image shot by the shooting means 3 by means of the image transmitting means 6, the image may be transmitted as digital signals by converting the signal from analogue to digital by means of the A/D converter (not shown), and the image to be displayed on the first or the second display means may be mirror reversed.

With the remote face-to-face communication apparatus of the present invention in this arrangement, the users who have a dialog with each other using the communication apparatus can exchange glance with each other. Since the user can check his/her own facial expression that is to be transmitted to the other party, a natural conversation with realistic sensations is realized. According to the present invention, the image received from another communication apparatus is reflected off the mirror and the half mirror, the image which is not mirror reversed can be seen. In addition, by displaying the user's own image displayed on the second display means capable of being switched between ON and OFF, the self-facial expression can be checked only when needed.

What is claimed is:

1. A remote face-to-face communication apparatus in which the user can exchange glance with other users and can check self-facial expression, connected to other communication apparatus to be used in the communication system for transmitting the images of the users between each communication apparatus comprising:
shooting means disposed in the direction of the user's sight line;
first display means for displaying the image received from other communication apparatuses;
second display means for displaying the image shot by the shooting means; and
image transmitting means for distributing and transmitting the image shot by the shooting means to other communication apparatus and the second display means,
wherein a half mirror being disposed on the optical axis of the shooting means and a mirror being disposed at the position opposing to the half mirror, whereby the image of the user passed through the half mirror is shot and the image displayed on the first display means is reflected off the mirror and the half mirror to make it visible to the user.

2. The remote face-to-face communication apparatus in which the user can check his/her facial expression according to claim 1, wherein the image displayed on the second display means as well as the image displayed on the first display means are reflected off the mirror and the half mirror to make it visible to the user.

3. The remote face-to-face communication apparatus in which the user can check his/her facial expression according to claim 1 or 2, wherein the first display means and the second display means are combined so that the image shot by the shooting means and the image received from another communication apparatus are combined to be displayed.

4. The remote face-to-face communication apparatus in which the user can check his/her facial expression according to claim 1 or 2, wherein the first display means and the second display means are combined so that either the image shot by the shooting means or the image received from another communicating apparatus is selected to be displayed.

5. The remote face-to-face communication apparatus in which the user can check his/her facial expression according to claim 4, wherein the image is selected by a foot switch to be displayed.

6. The remote face-to-face communication apparatus in which the user can check his/her facial expression according to any one of claims 1 to 5, wherein the image shot by the shooting apparatus and distributed and transmitted to the second display means is mirror reversed in the image transmitting means to be output.

7. The remote face-to-face communication apparatus in which the user can check his/her facial expression according to any one of claims 1 to 6, wherein the image shot by the shooting means and distributed and transmitted to the second display means is displayed on the second display means so as to be capable of switching between ON and OFF.
